(19) United States
(12) Patent Application Publication
(10) Pub. No.: US 2016/0030973 A1
(43) Pub. Date: Feb. 4, 2016

(54) UNIVERSAL PAINT APPLICATOR AND PAINT CONTAINERS WITH HANDLES

(71) Applicant: Kevin Troudt, Seattle, WA (US)

(72) Inventor: Kevin Troudt, Seattle, WA (US)

(21) Appl. No.: 14/726,976

(22) Filed: Jun. 1, 2015

Related U.S. Application Data
(63) Continuation of application No. PCT/US2013/072763, filed on Dec. 3, 2013.
(60) Provisional application No. 61/732,914, filed on Dec. 3, 2012.

(51) Int. Cl. B05C 17/02

(52) U.S. Cl. CPC B05C 17/022; B05C 17/0245

(57) ABSTRACT

A paint applicator configured for use in combination with a hollow-core paint roller cover includes a handle and a pair of pivot arms extending therefrom. Each pivot arm includes a proximate end rotatably mounted to the handle and an opposite, distal end to which is pivotably mounted a hub assembly. A pivot arm actuator is cooperatively linked to the pivot arms such that movement of the actuator in a first direction causes the pivot arms to rotate toward one another and movement of the actuator in a second direction causes the pivot arms to rotate away from one another. Each hub assembly includes a rotatable hub with an outer surface configured to frictionally engage the inside surface of the roller cover such that, when the pivot arms are rotated toward one another, the hubs enter and retain the roller between the pivot arms.

### CROSS-REFERENCE TO RELATED APPLICATION/PRIORITY CLAIMS

The present application is a continuation of International Application Serial No. PCT/US2013/072763 filed Dec. 3, 2013 pursuant to the Patent Cooperation Treaty, and titled “UNIVERSAL PAINT APPLICATOR AND PAINT CONTAINER WITH HANDLE.” Application PCT/US2013/072763 claimed priority benefits in U.S. Non-Provisional application Ser. No. 14/093,686 filed Dec. 2, 2013 and under the title “UNIVERSAL PAINT APPLICATOR,” which, as of the filing date of the present application, was still pending before the US Patent and Trademark Office. U.S. application Ser. No. 14/093,686 in turn claimed priority based on U.S. Provisional Application Ser. No. 61/732,914 filed Dec. 3, 2012 under the title “UNIVERSAL PAINT APPLICATOR AND GRIPPING TRAY.”

The present application claims the benefit of the filing date of Provisional Application Ser. No. 61/732,914, as well as the filing dates of U.S. Non-Provisional application Ser. No. 14/093,686 and PCT Application No. US2013/072763, based on the priority chain outlined above. Moreover, the entireties of the disclosures, including the drawings, of all of the previous applications in the aforesaid priority chain are incorporated herein by reference as if set forth fully in the present application.

### NOTICE OF LIENS ON PATENT APPLICATIONS

Notice is given herein that an Attorney's Lien was previously filed and recorded in connection with U.S. application Ser. No. 14/093,686 and PCT Application No. US2013/072763. These liens are a matter of public record, and were recorded by the US Patent and Trademark Office Assignment Division at Reel/Frame 033251/0872. Additionally, liens in these applications have been recorded pursuant to the Uniform Commercial Code in the State of Washington and the Commonwealth of Massachusetts. Moreover, even in the absence of any additional recordation, the previously recorded lien(s) applies to the present application since this application derives from both of the aforesaid applications. Because the lien(s) are binding on assignees, licenses and successors in interest, the public records identified above should be consulted to ascertain the status of the liens before rendering consideration for an assignment or license of rights.

### BACKGROUND

Although not so limited is utility or scope, embodiments of the present invention relate generally to paint applicators and, more particularly, to paint roller systems or roller-type applicators that employ a roller cover including a cylindrical tubular roller core with an inside surface and an outside surface with a nap or pile of absorbent material configured to alternatively absorb and distribute paint.

Decorative painting of surfaces such as walls and ceilings with a roller-type applicator can be challenging and messy. Even professional painters are continually confronted with time-intensive preparation techniques, difficult-to-reach locations, lengthy take-down and cleanup routines, and awkward painting tools. Novice painters face even more daunting challenges when undertaking a home improvement painting project because they are not familiar with best painting practices or tools. Generally, paint is difficult to remove from carpets, drapery, clothing, and the like. If done improperly, a painting project can quickly spiral into something undesirable.

Conventional roller-type paint applicators cause “fat edge” to accumulate along the edges of the roller because of an imbalance of pressure caused by the general hook-shape of a paint roller applicator in which the roller cover is support for rotation from only one side. Additionally, it is difficult and unpleasant to change a wet paint roller cover with a replacement roller cover because the painter frequently comes in contact with wet paint and spreads it to clothes, floors, or other nearby items. Moreover, conventional paint trays are inconvenient to grasp and move from one location to another without spilling the paint or causing the paint to splash.

Accordingly, there exists a general need for improved apparatus and associated methods for applying paint with roller covers and, more particularly, for a universal roller-type paint applicator that (i) can accommodate roller covers of different lengths, (ii) facilitates rapid, tidy and hands-free changing of roller covers and (iii) facilitates the application of more balanced force to each end of a roller cover during application in order to avoid “fat edge,” which is a term employed by some painters to indicate the undesired, uneven accumulation of paint on one side of the roller resulting in uneven application.

### SUMMARY

In an illustrative embodiment, a universal paint applicator is configured for use in combination with a roller cover including a cylindrical roller-cover core with an inside surface and an outside surface carrying an absorbent material for alternatively absorbing and depositing paint on a surface. The applicator includes a handle assembly (alternatively referred to as a “handle”) that extends longitudinally along a handle axis. Carried by, and extending forwardly of, the handle are first and second pivot arm assemblies which, as further explained below, are configured for the cooperative retention and release of a roller cover.

Each pivot arm assembly includes a pivot arm having a proximate end by which it depends from the handle assembly for rotation about a pivot arm axis and a distal end located opposite the proximate end and disposed forwardly of the handle assembly. A bi-directional pivot arm actuator is carried by the handle and cooperatively linked to each pivot arm assembly such that movement of the actuator in a first direction causes the pivot arms to rotate toward one another and movement of the actuator in a second direction, opposite the first direction, causes the pivot arm assemblies to rotate away from one another. In a typical version, the pivot arm assemblies, while extending forwardly of the handle, are disposed with general symmetry about the handle axis which, it is to be understood, is an imaginary line of infinite length extending through the handle.

Coupled to the distal end of each of the first and second pivot arms is a hub assembly. Each hub assembly is pivotably coupled to its respective pivot arm for angular movement, relative to that pivot arm, about a hub-pivot axis. In various versions, the degree of angular hub movement is limited by design to be within a predetermined angular range so as to facilitate proper hub alignment for “capturing” a roller cover between the hubs, an aspect that will be more fully appreciated upon further examination of the specification. Additionally, the hubs of some versions include hub caps that are tapered or conical in order to guide and align each hub into the roller-cover core as the inwardly-facing hubs are drawn toward one another.

Each hub assembly includes a hub axle and a hub mounted for rotation on the hub axle about a hub-rotation axis defined by the hub axle. The hub includes an outer surface configured to frictionally engage the inside surface of the roller-cover core such that the hubs of the first and second pivot arms cooperate to retain the roller cover between the pivot arms. Moreover, the hub-rotation axes, hub-pivot axes and pivot arm axes are movable into disparate mutual orientations such that, when the pivot arms are mutually spread to various degrees, the hub-rotation axes can be aligned to define a common roller-cover rotation axis so that the roller cover cooperatively retained by the hubs can be of any length between a predetermined minimum length and a pre-determined maximum length.

In one alternative configuration, bi-directional pivot arm actuation is facilitated in part by the inclusion at the proximate end of each pivot arm of a pivot arm gear having pivot-gear teeth. The pivot arm actuator comprises a worm-drive shaft carrying a worm gear with teeth that intermesh with the pivot-gear teeth of each pivot arm. Thusly assembled, that rotation of the worm-drive shaft in a first direction causes the pivot arms to rotate about their pivot arm axes inwardly toward one another, while rotation of the worm-drive shaft in a second direction opposite the first direction causes the pivot arms to mutually spread apart in an outwardly direction. The inward (i.e., toward “clamping”) and outward (i.e., spreading) motion of the pivot arms facilitate, respectively, engagement and disengagement of the outer surfaces of the hubs with the inside surface of the roller-cover core.

In another illustrative configuration, the worm-drive shaft and worm gear are omitted. Instead, the pivot-gear teeth of the first pivot arm assembly are directly intermeshed with the pivot-gear teeth of the second pivot arm assembly such that the rotation of one of the pivot arms in one of an inwardly and outwardly direction causes the rotation of the other pivot arm in, respectively, an inwardly and outwardly direction with respect to the handle axis. Accordingly, in this configuration, each pivot arm thereby serves as the bi-directional pivot arm actuator for the other pivot arm.

In addition to various universal paint applicators, alternatively configured paint receptacles and associated handle assemblies are herein described. In one embodiment, a combination paint receptacle and handle assembly for lifting the receptacle includes a paint receptacle configured for temporarily containing liquid paint to be applied to a surface. The receptacle includes a closed bottom wall and at least one side wall joined to, and extending upwardly from, the bottom wall toward an open receptacle top end defined by a top-end periphery. The periphery includes at least one outwardly extending receptacle lip having a lip underside. A handle unit includes a hand-grip portion and first and second prongs depending from the hand-grip portion. The prongs are mutually spaced apart and configured such that each of the prongs can selectively engage at least one lip underside such that a user can lift the paint receptacle by the hand-grip portion.

Representative embodiments are more completely described and depicted in the following detailed description and the accompanying drawings.

### BRIEF DESCRIPTION OF THE DRAWINGS

FIG. 1 is a cross-sectional/“transparent” view of an illustrative universal paint applicator;

FIG. 2 is an exploded view of the universal paint applicator of FIG. 1;

FIG. 3 is an exterior assembled view of the universal paint applicator of FIGS. 1 and 2;

FIG. 4 depicts an illustrative universal paint applicator retaining for rotation between a pair of pivot arms a cylindrical roller cover of predetermined length;

FIG. 5 shows the paint applicator of FIG. 4 retaining a roller cover of lesser length than the roller cover of FIG. 4, and the pivot arms drawn commensurately closer together;

FIG. 6 depicts the intermeshing of the pivot-gear teeth of alternatively configured roller-retaining pivot arms;

FIG. 7 is a cross-sectional detail of an illustrative hub assembly;

FIG. 8 is a perspective view of an illustrative paint tray with an associated carrying grip and handle;

FIG. 9 is an alternative view of the paint tray of FIG. 9;

FIG. 10 depicts various paint containers (e.g., trays, cans or pails) with variously configured grip and handle structures associated therewith;

FIG. 11A is a perspective view of a combination paint receptacle and handle unit before the handle unit has been engaged with the paint receptacle;

FIG. 11B is a side view of the handle unit and paint receptacle of FIG. 11A mutually engaged such that the receptacle can be lifted by the handle unit; and

FIGS. 12A and 12B include two schematic views of a paint tray formed from a sheet of material.

### DETAILED DESCRIPTION

The following description of variously embodied universal paint applicators is demonstrative in nature and is not intended to limit the invention or its application of uses. Accordingly, the various implementations, aspects, versions and embodiments described in the summary and detailed description are in the nature of non-limiting examples falling within the scope of the appended claims and do not serve to define the maximum scope of the claims.

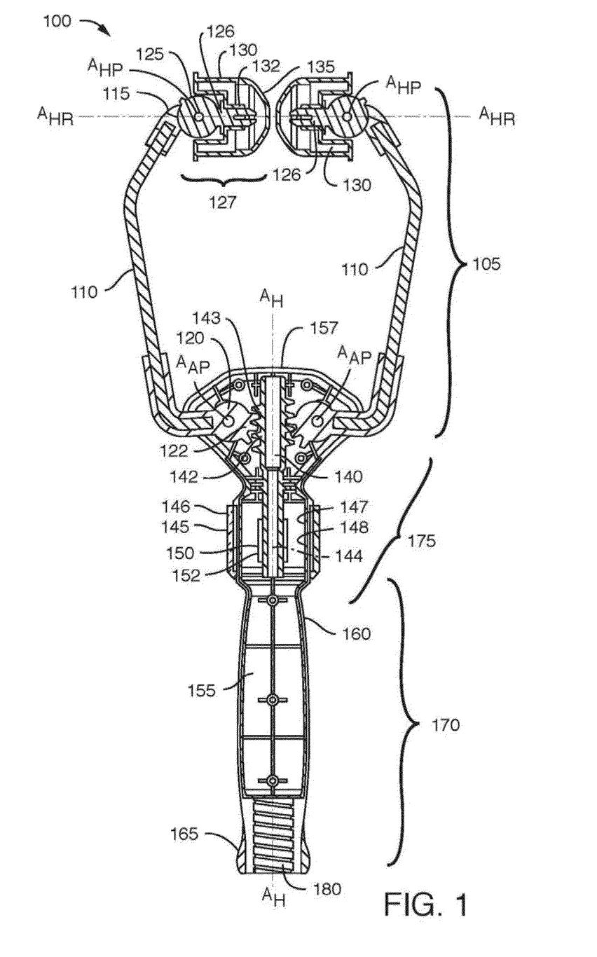

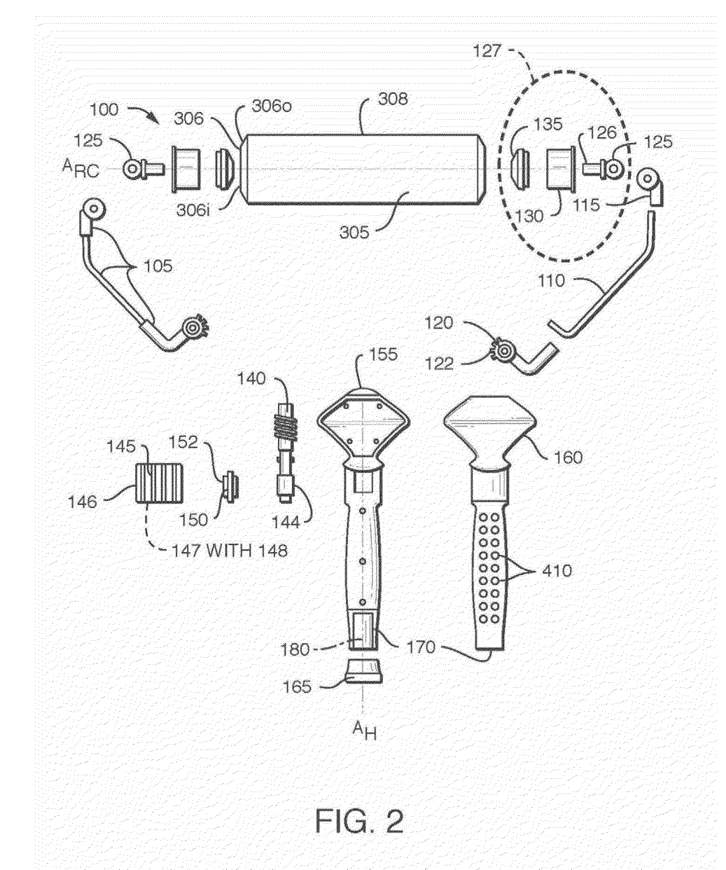

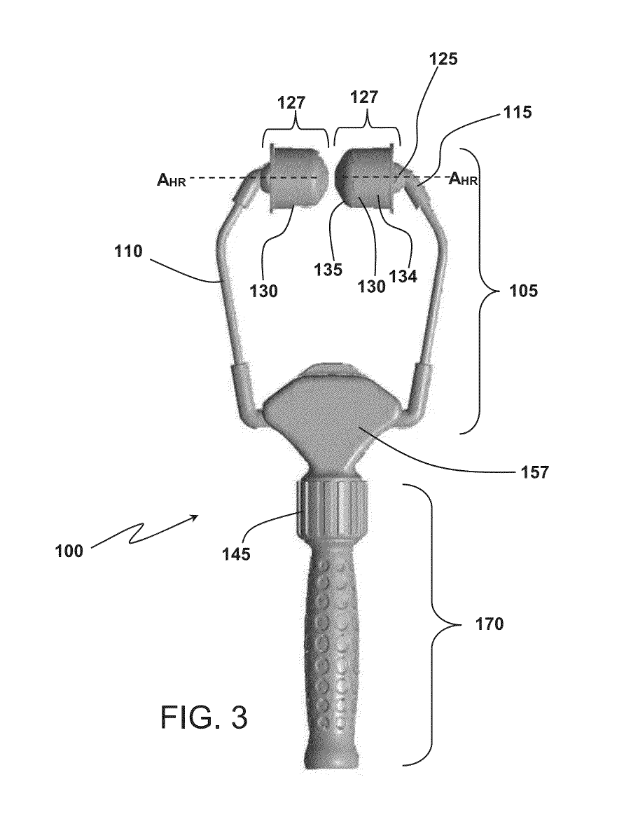

With initial reference to the cross-sectional/“transparent” view of FIG. 1, the exploded view of FIG. 2 and the exterior assembled view of FIG. 3, an illustrative embodiment of a universal paint applicator 100 features a dual pivot arm configuration that, among other advantages, provides shock-absorption and force balancing that facilitate even paint application. More specifically, the paint applicator 100 includes a pair of pivot arm assemblies 105 comprising first and second pivot arm assemblies 105 that are not individually identified as such because their individual identification as “first” and “second” is arbitrary. The pivot arm assemblies 105 are carried by, and extend forwardly of, a handle assembly 170 that extends longitudinally along a handle axis A_{H} about which handle axis A_{H} the pivot arm assemblies 105 are disposed symmetrically. The pivot arm assemblies 105 cooperatively function as a spring when pressure is applied to the handle assembly 170 during painting. That is, as force is applied to the handle assembly 170 during painting, the pivot arm assemblies 105 flex and deflect in an outwardly direction, thereby providing a shock-absorbing feature, as further described below.

Each pivot arm assembly 105 includes a pivot arm 110, a pivot axle base 115, and a pivot arm gear 120. Because the pivot arm gear 120 of each pivot arm assembly 105 is more proximate the handle assembly 170 than is the pivot axle base 115, the opposed ends of each pivot arm 110 coupled to the pivot arm gear 120 and the pivot axle base 115 may alternatively be referred to as, respectively, the proximate and distal ends of that pivot arm 110.

With initial reference to either or both of FIGS. 1 and 2, a hub assembly 127 is pivotably coupled to each pivot axle base 115 for angular movement (i.e., rotation or pivoting) about a hub-pivot axis A_{HP}. In the illustrative embodiment of FIG. 1, the hub-pivot axes A_{HP} are shown as extending through and perpendicularly to the plane of the drawing sheet, as well as orthogonally to the handle axis A_{H}. Each hub assembly 127 includes a pivot axle 125, a hub 130 and a hub cap 135. The pivot axle 125 by which the hub assembly 127 is pivotably mounted to the pivot axle base 115 of the pivot arm assembly 105 has extending therefrom a hub axle 126 on which the hub 130 is mounted for rotation about a hub-rotation axis A_{HR}. More specifically, as shown in FIG. 1, an illustrative hub 130 has a cylindrical central channel 132 extending therethrough that is configured to receive, and be retained for rotation by, the hub axle 126.

As shown, for example, in FIGS. 2, 4 and 5, the opposed hubs 130 carried by the pivot arms 110 cooperate to engage and retain a cylindrical paint applicator which, for purposes of the present description and claims, is in the form of a roller cover 305. A typical roller cover 305 includes a cylindrical tubular roller-cover core 306 with inside and outside surfaces 306ᵢ and 306ₒ and a nap 308 (or pile) of absorbent material carried by the outside surface 306o and configured to alternatively absorb paint from a paint source (not shown) and deposit that paint on a surface (not shown). Each hub 130 includes a cylindrical outer surface 134 configured to frictionally engage the inside surface 306i of the roller-cover core 306, and retain the roller cover 305 between the pivot arms 110.

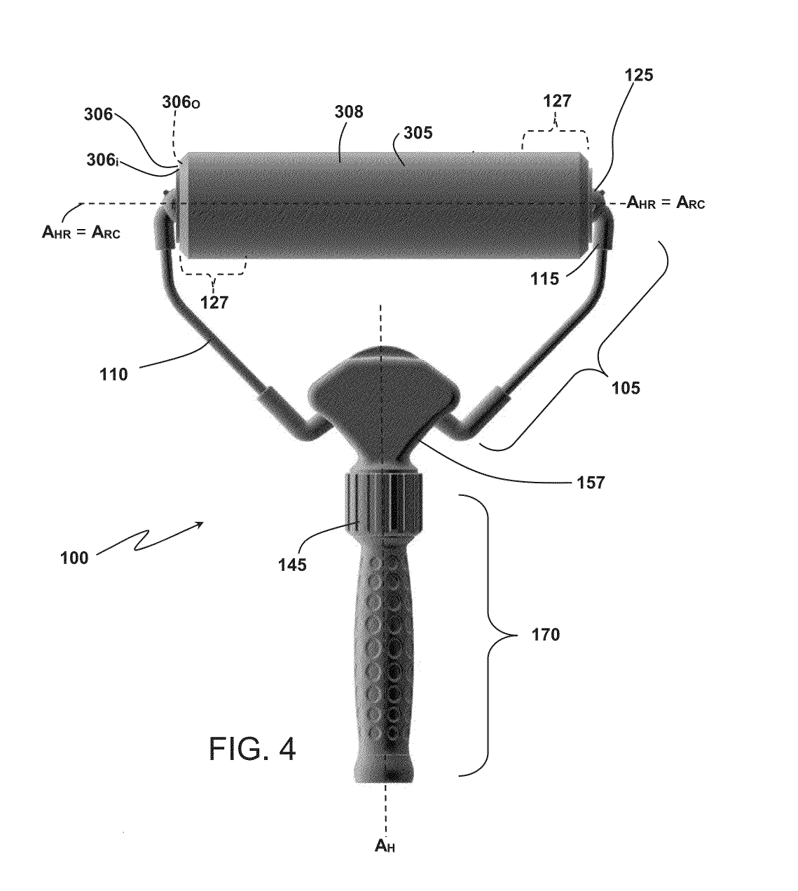

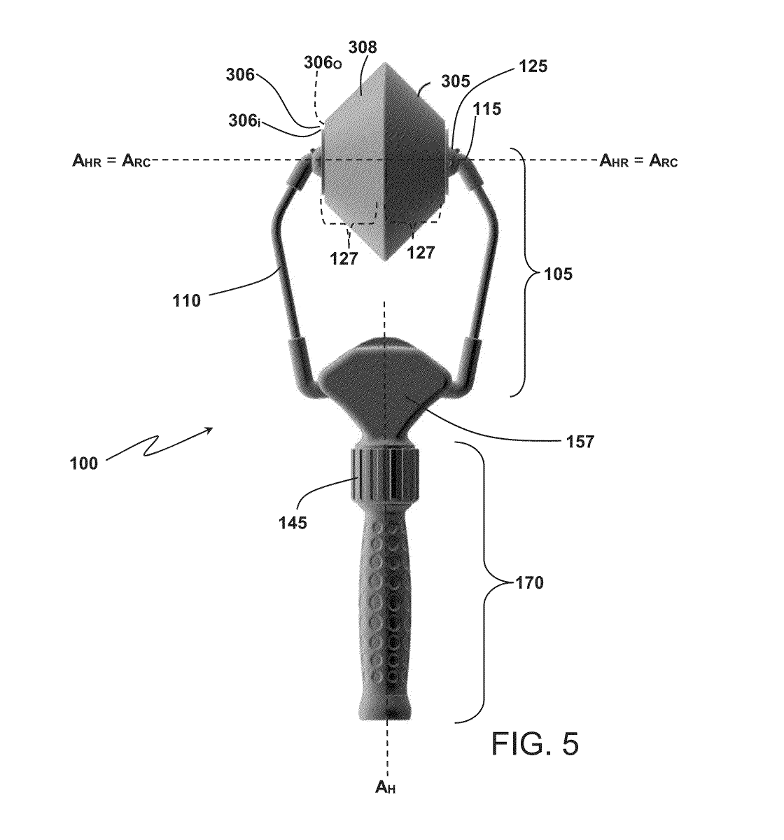

The pivotability of the pivot arms 110 and the hub assemblies 127 with respect to the pivot arms 110 permit the hub-rotation axes A_{HR} defined by the hub axles 126 to align along a common (i.e., “single” or “shared”) roller-cover rotation axis A_{RC} for roller covers 305 of various widths. In fact, the disparate roller lengths that can be accommodated by any given embodiment is theoretically infinite between some minimum and maximum widths corresponding to, respectively, contact between the hubs 130 and the maximum spread of the pivot arms 110. Moreover, as illustrated by comparison of FIGS. 4 and 5, roller covers 305 having disparately configured naps 308 can also be accommodated; FIG. 4 depicts a conventional cylindrical roller cover 305, while the roller cover 305 of FIG. 5 is configured for painting a corner defined by the intersection of two planar surfaces such as two walls or a wall and a ceiling (not shown).

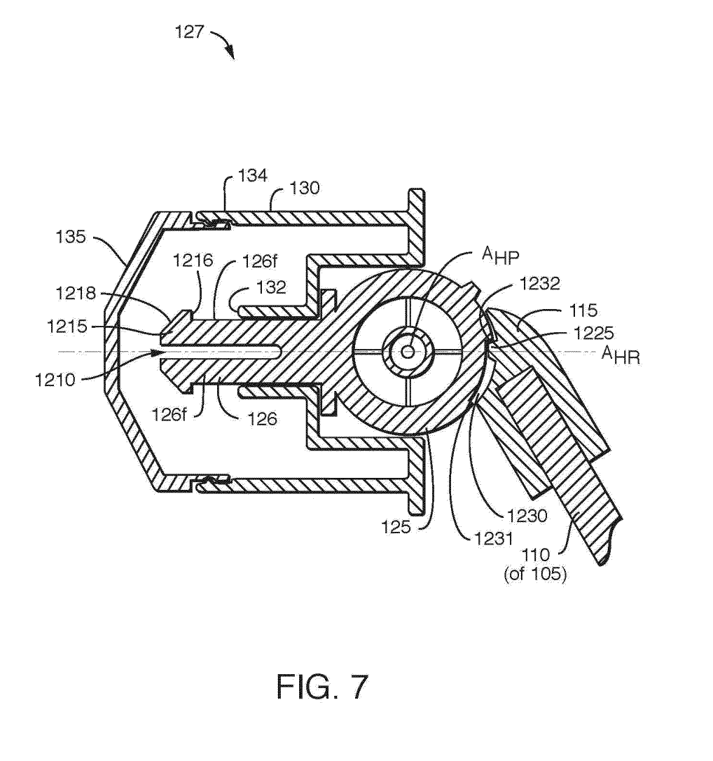

Although in the version of FIG. 1 the central channel 132 and hub axle 126 are of relative sizes (i.e., axial lengths) that permit little, in any, lineal (axial) displacement of the hub 130 along the hub-rotation axis A_{HR} defined by the hub axle 126, embodiments are envisioned in which the hub axle 126 is longer than the central channel 132 of the hub 130 such that the hub 130 is capable of lineal displacement along the hub axle 126. One such embodiment is shown in FIG. 7, which will be described in some detail later in this description. Presently, it is sufficient to note that lineal displacement of the hub 130 along the hub axle 126 allows the pivot arms 110 of alternative versions to flex outwardly while retaining a roller cover 305 without forcing the hubs 130 out of the roller-cover core 306. Allowing the pivot arms 110 to flex provides the aforementioned shock absorption and helps to balance forces applied to the roller cover 305 for more even application of paint.

As described with initial and principal reference to FIG. 1, the paint applicator 100 includes an applicator housing 157 that is attached to the handle assembly 170 and to which each pivot arm 110 is mounted for rotation about an arm-pivot axis A_{AP}. As seen in the version of FIG. 1, the arm-pivot axes A_{AP} extend orthogonally to the handle axis A_{H} and, at least in the case shown, parallel with the hub-pivot axes A_{HP} in order to achieve the movements hereinabove and hereinbelow described. The housing 157 encloses a gear assembly 175. Pivot-gear teeth 122 on the pivot arm gear 120 of each pivot arm assembly 105 intermesh with the teeth 143 of a worm gear 142 carried by worm-drive shaft 140. Thusly assembled, rotation of the worm-drive shaft 140 in a first direction causes the pivot arm assemblies 105 to simultaneously clamp together in an inwardly direction to secure a roller cover 305 between the hubs 130. Conversely, rotation of the worm-drive shaft 140 in a second direction opposite the first direction causes the pivot arms 110 to mutually spread outwardly in symmetric fashion and either (i) release a roller cover 305 retained thereby or (ii) allow for installation of a new roller cover 305. In other words, the pivot arm assemblies 105 are configured to simultaneously rotate in opposite directions relative to the housing 157. Thus, the roller cover 305 can be secured to and released from the universal paint applicator 100 in a “hands free” manner, thereby facilitating simple, quick and less messy changing of roller covers 305.

As in the embodiment of FIGS. 1 and 2, the worm-drive shaft 140 is typically enclosed within the applicator housing 157. In order to facilitate a user's rotation of the worm-drive shaft 140 from the exterior of the housing, the applicator 100 of FIG. 1 illustratively includes a ring gear 145 disposed coaxially with the worm-drive shaft 140 and having an annular exterior surface 146 that is at least partially accessible from the exterior of the applicator housing 157. In the version of FIGS. 1, 2 and 3, the ring gear 145 is essentially a collar with the exterior surface 146 annularly disposed about a portion of the handle assembly 170. An interior surface 147 of the ring gear 145 carries internal ring-gear teeth 148, the purpose of which will be subsequently described.

With continued reference to FIG. 1, but especially the exploded view of FIG. 2, when assembled, a planet gear 150 is disposed between the interior surface 147 of the ring gear 145 and the portion of the cylindrical outer surface of the worm-drive shaft 140. The planet gear 150 has external planet-gear teeth 152 that intermesh with the internal ring-gear teeth 148. Moreover, the worm-drive shaft 140 carries external drive-shaft teeth 144 that intermesh with the external planet-gear teeth 152. It will be readily appreciated by a person of ordinary skill in the relevant art, and a person with general mechanical knowledge, that, when the aforesaid components are thusly assembled, rotation of the ring gear 145 causes rotation of the planet gear 150 and, in turn, rotation of the worm-drive shaft 140 by the rotating planet gear 150, thereby causing the pivot arm assemblies 105 to pivot toward or away from one another to retain or release a roller cover 305.

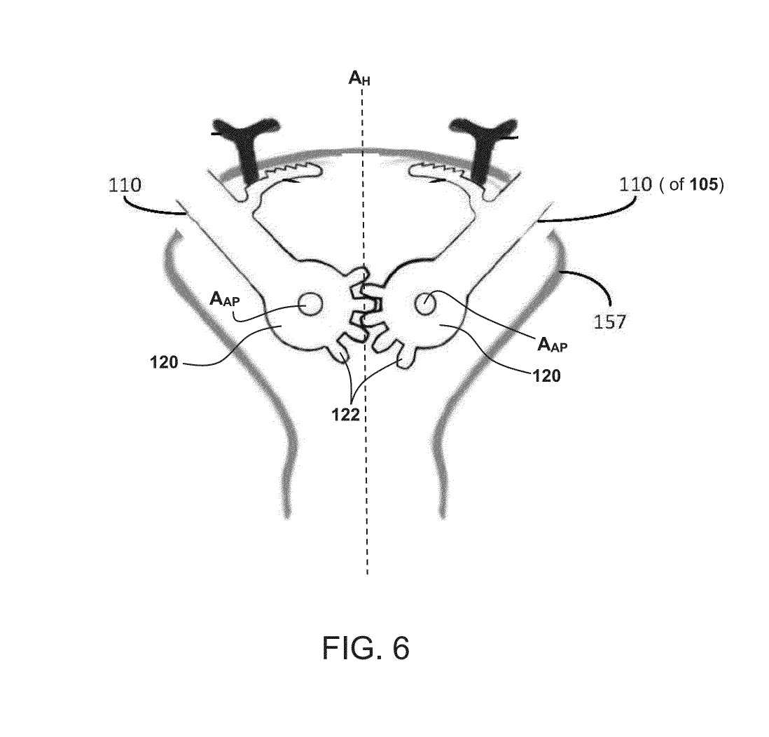

With reference now to FIG. 6, in which components relevant to the present discussion are isolated, illustrative alternative mechanics for actuating the pivot arms 110 toward and away from one another are shown and described. In the version of FIG. 6, in which “like components” relative to alternative versions are identified by “like reference characters,” the pivot-gear teeth 122 of the first pivot arm assembly 105 are directly intermeshed with the pivot-gear teeth 122 of the second pivot arm assembly 105, wherein, again, the identification of the assemblies 105 as “first” and “second” is purely arbitrary. Thusly configured, the rotation of one of the pivot arms 110 in an inwardly direction, relative to the handle axis A_{H}, causes the other pivot arm 110 to rotate inwardly such that the pivot arms 110 are drawn more closely together. Conversely, the rotation of one of the pivot arms 110 in an outwardly direction, relative to the handle axis A_{H}, causes the other pivot arm 110 to rotate outwardly such that the pivot arms 110 are spread farther apart. Accordingly, while in the illustrative embodiment in which a worm-drive shaft 140 and associated components serve as a bi-directional pivot arm actuator, in the version presently under discussion, each pivot arm 110 serves as the bi-directional pivot arm actuator for the other pivot arm 110.

Although the construction of the handle assembly 170 is of no particular consequence, FIG. 2 depicts an embodiment in which the handle assembly 170 includes first and second handle members 155 and 160 which are selectively held together in part by a retaining ring 165. Exterior surfaces of the handle members 155 and 160 may include undulations such as, by way of non-limiting example, indentations 410 (of FIG. 3) in order to facilitate gripping. The indentations 410 may be circular, elliptical, oval or of any other advantageous configuration. Internal threads 180 disposed within a bottom portion of the handle assembly 170 can receive an extension pole or rod (not shown) so that the universal paint applicator 100 can be extended to reach high regions of a wall or a ceiling, for example.

Referring to FIG. 7, the details of an illustrative hub assembly 127 are now revisited. As previously described, a hub assembly 127 includes a pivot axle 125, a hub 130 and a hub cap 135. The hub cap 135 is tapered in order to facilitate insertion into a roller-cover core 306, as described in the summary.

In order to facilitate retention and removal of the hub 130 from the hub axle 126, the hub axle 126 is split to define at least one slot 1210 extending along the hub-rotation axis A_{HR}. More specifically, by virtue of the slot 1210, the hub axle 126 includes at least two axle fingers 126f extending in parallel along the hub-rotation axis A_{HR}. Each finger 126f terminates in a hub retainer 1215 that has a flanged catch 1216 and a sloped surface 1218 that angles toward the hub-rotation axis A_{HR} in a direction moving away from the pivot axle 125 from which the hub axle 126 depends. The fingers 126f can be temporarily flexed toward one another to allow a hub 130 to be mounted over, and retained by, the hub axle 126. More specifically, the hub retainers 1215 are configured to extend wider than the diameter of the central channel 132 in the hub 130 such that, as the sloped surfaces 1218 of the hub retainers 1215 are urged into the central channel 132, the fingers 126f flex inwardly and that the fingers 126f and hub retainers 1215 can pass through the central channel 132. Once the hub retainers 1215 emerge from the other side of the central channel 132, the fingers 126f spread back out to their non-flexed attitudes, and the hub 130 is axially retained by the flanged catches 1216. To remove the hub 130, the fingers 126f are flexed inwardly so that the hub retainers 1215 can pass back out through the central channel 132.

As indicated in the summary relative to some embodiments, the extent of angular movement between the hub assembly 127 and the pivot arm 110 to which the hub assembly 127 is coupled is intentionally limited. More specifically, it is advantageous for the hubs 130 to be facing generally inwardly toward the handle axis A_{H}, but to have some degree of angular movement in order to facilitate “capture” of a roller cover 305, as well as the retention of roller covers 305 of various lengths. To this end, illustratively configured components are shown in FIG. 7 in which the pivot axle 125 has defined therein an arcuate slot 1230 (or “race”) centered on the hub-pivot axis A_{HP} and defined by first and second slot ends 1231 and 1232. Protruding from the pivot axle base 115, and into the slot 1230, is a pivot stop 1225 that defines the extremes of angular motion for the hub assembly 127 in each direction by abutting engagement with, alternatively, the first and second slot ends 1231 and 1232. The degree of angular freedom—or range of pivot or rotation—in such an embodiment will obviously depend on the arc length of the arcuate slot 1230. While a single example of how angular motion of the hub assembly 127 is limited is provided for illustrative purposes, it is to be understood that the example provided is by no means limiting of the manner in which said angular motion can be limited, and that the more important overall concept is that the pivot range of the hub assembly 127 can be limited to within a predetermined angular range by any suitable means.

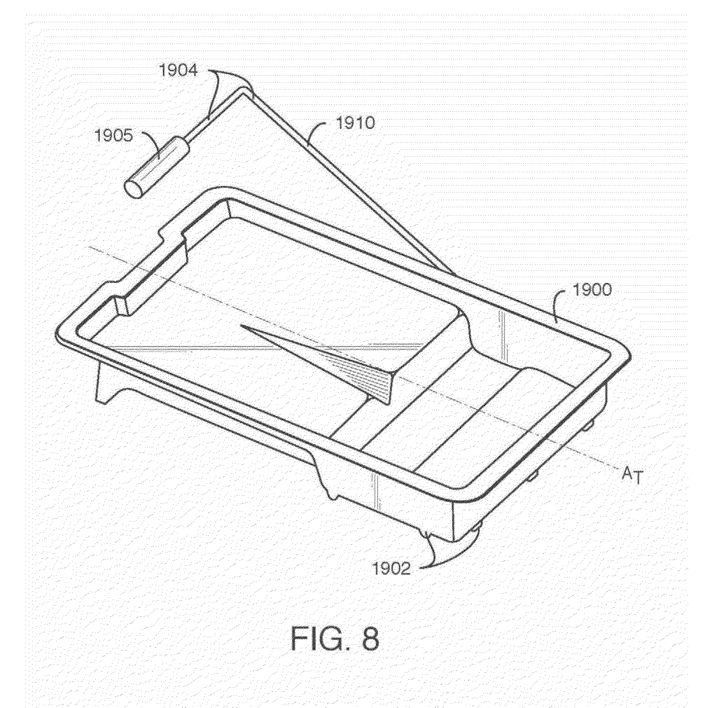

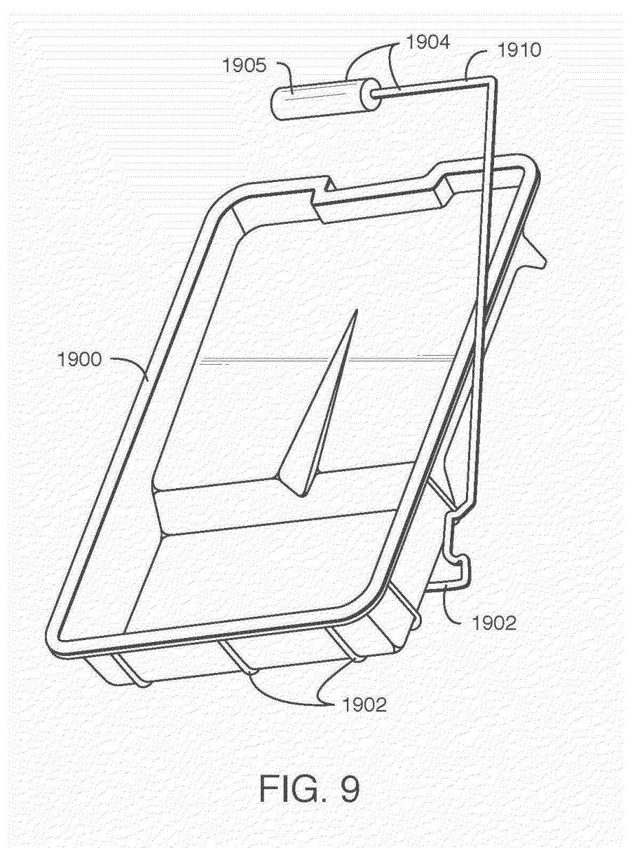

With reference to FIGS. 8 through 10, variously configured paint receptacles (e.g., trays, pails and other containers) and associated handle assemblies suitable for use in conjunction with the universal paint applicator 100 are shown and described. FIGS. 8 and 9 illustrate perspective views of an illustrative paint tray 1900 with an associated cradle 1902 for supporting the paint tray 1900 from the bottom thereof. In the illustrative embodiments of FIGS. 8 and 9, the cradle 1902 is a basket-like grid of wire or metal rod configured to support the paint tray 1900 at various contact points. A handle assembly 1904 is integrally formed or otherwise connected to the cradle 1902 and includes a handle-grip 1905 depending from a connector portion 1910 that joins the handle-grip 1905 to the cradle 1902. The connector portion 1910 rises along a side of a paint tray 1900 supported by the cradle 1902 and bends inwardly so that the handle-grip 1905 supported thereby is over the paint tray 1900. More specifically, the handle-grip 1905 of various embodiments, including that of FIGS. 8 and 9 is situated so that, when the tray 1900 contains paint (not shown), the load is easily balanced and the paint tray 1900 remains at or near level. Ideally, the handle-grip 1905 is located directly above the location of the center of gravity (not indicated) of paint tray 1900 and the paint contained therein. However, it will be readily appreciated that, because of the irregular shape of the bottom of the paint tray 1900, the center of gravity will move as a function of the amount of paint in the tray 1900 and the tray 1900 might tilt at more or less of an angle. However, if the angle is always sufficiently small, tilting should not be problematic. The handle-grip 1905 allows the user to easily grasp, manipulate and relocate the tray 1900 without touching the tray 1900 itself. In this manner, the user need not get messy with paint. The handle 1910 is angled relative to the tray 1900 so that a paint applicator, such as paint applicator 100, can be easily dipped or rolled in the paint (not shown) contained within the tray 1900.

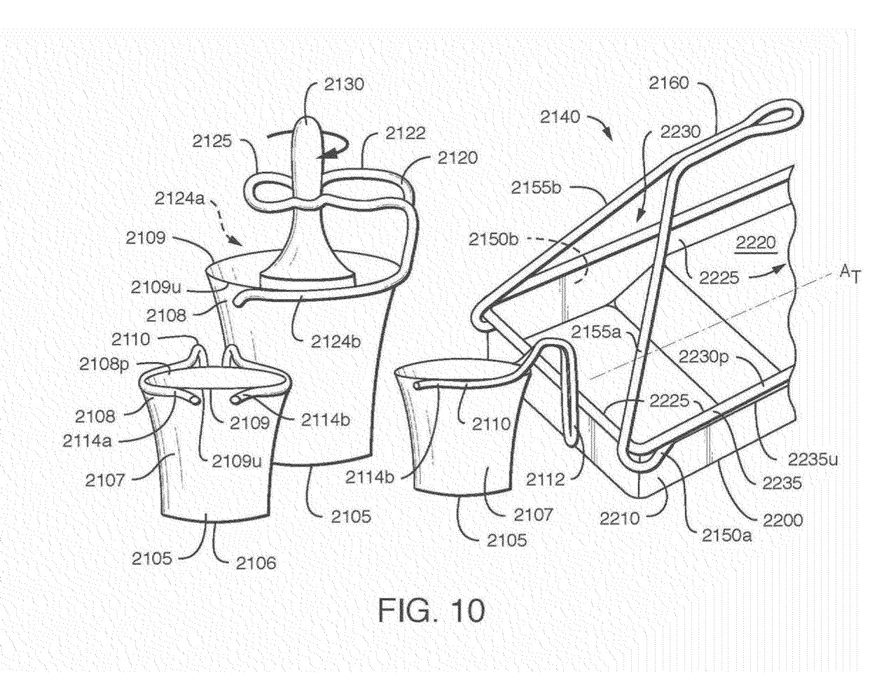

FIG. 10 depicts various paint receptacles 2105 (e.g., trays, cans and pails) with variously configured grip and handle structures associated therewith. In one illustrative embodiment shown in association with each of the two shorter of the three pail-like paint receptacles 2105 of FIG. 10, a handle unit 2110 is configured to engage a receptacle (container) 2105 including a closed bottom wall 2106 and a single side wall 2107 extending upwardly from the bottom wall 2106. The side wall 2107 terminates at an open receptacle top end 2108 defined by a top end periphery 2108p. The top end periphery 2108p includes an outwardly extending receptacle lip 2109 with a lip underside 2109u.

The handle unit 2110, which is the same in association with each of the small receptacles 2105, but is shown twice to provide different views, includes a hand-grip portion 2112 and first and second prongs 2114a and 2114b depending from the hand-grip portion 2112. The prongs 2114a and 2114b are mutually spaced apart and configured such that each of the prongs 2114a and 2114b can selectively engage portions of the lip underside 2109u located on opposite sides of the periphery 2108p. In this way, a user can lift the paint receptacle 2105 without directly contacting it with his or hand.

While the particular construction of the handle units may vary, the illustrative embodiment identified as handle unit 2110 in FIG. 10 is made from a continuous piece of rod or “wire” that is contoured to define the hand-grip portion 2112 and prongs 2114a and 2214b. Because it is intended for use with a round receptacle 2105, the prongs are contoured to form arcuate prongs 2114a and 2114b. Moreover, this version of the handle unit 2110 is contoured such that, when the handle unit 2110 is engaged with a receptacle 2105, the hand-grip portion 2112 is located laterally to the outside of the side wall 2107 of the receptacle 2105.

In another embodiment, also shown in FIG. 10, a handle unit 2120 with first and second prongs 2124a and 2124b provides a similar engagement with a container, also identified as receptacle 2105. However, in this version, the handle unit 2120 is contoured such that, when the prongs 2124a and 2124b are engaged with the receptacle 2105, a hand-grip portion 2122 is situated above (i.e., over) the open receptacle top end 2108. Moreover, the hand-grip portion 2122 is contoured to define a paint brush handle holder 2125, which allows a paint brush handle 2130 to stand upright within the receptacle 2105. The paint brush handle 2130 can be twisted in an upright position to soak up paint into its brush bristles.

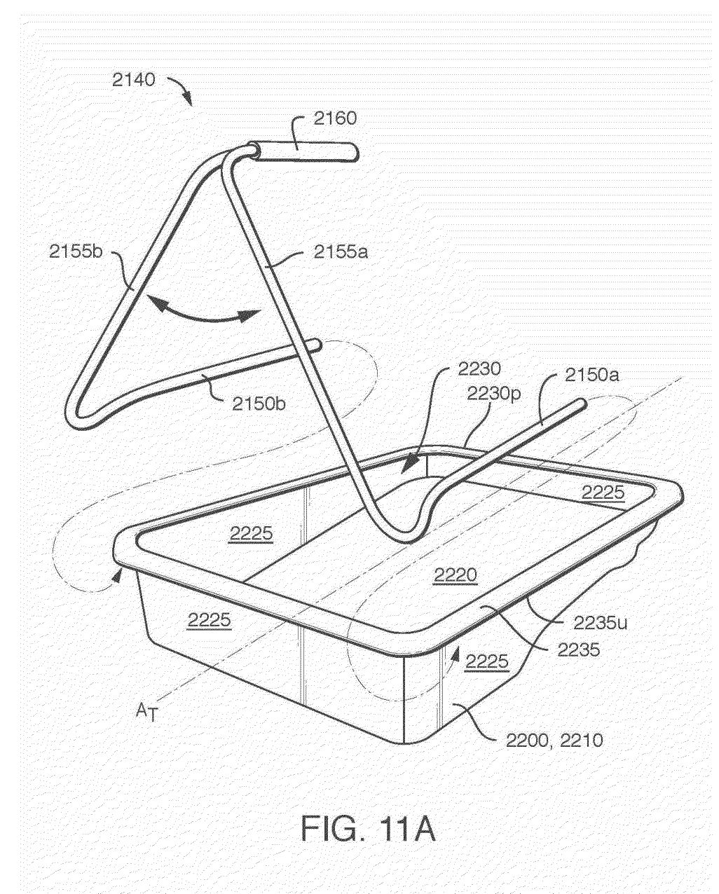

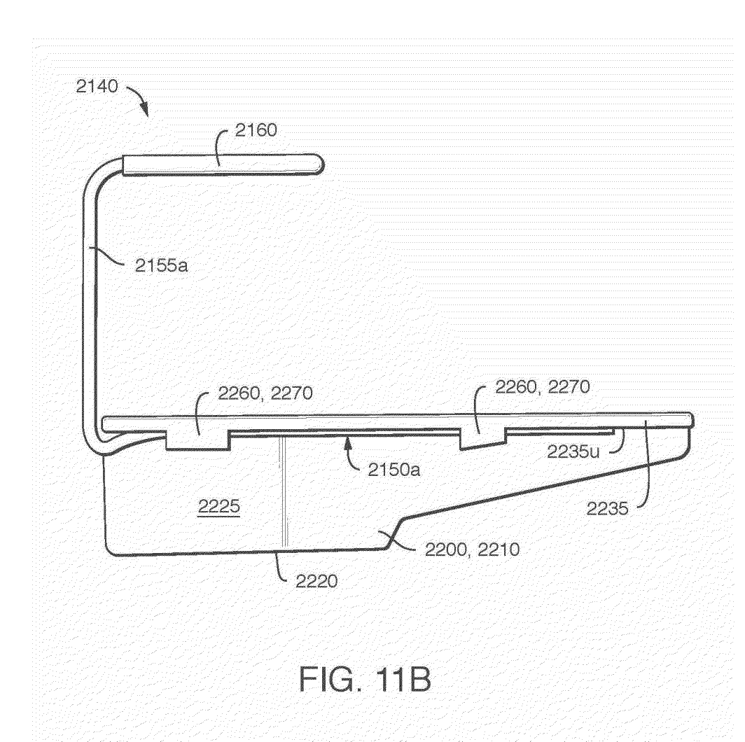

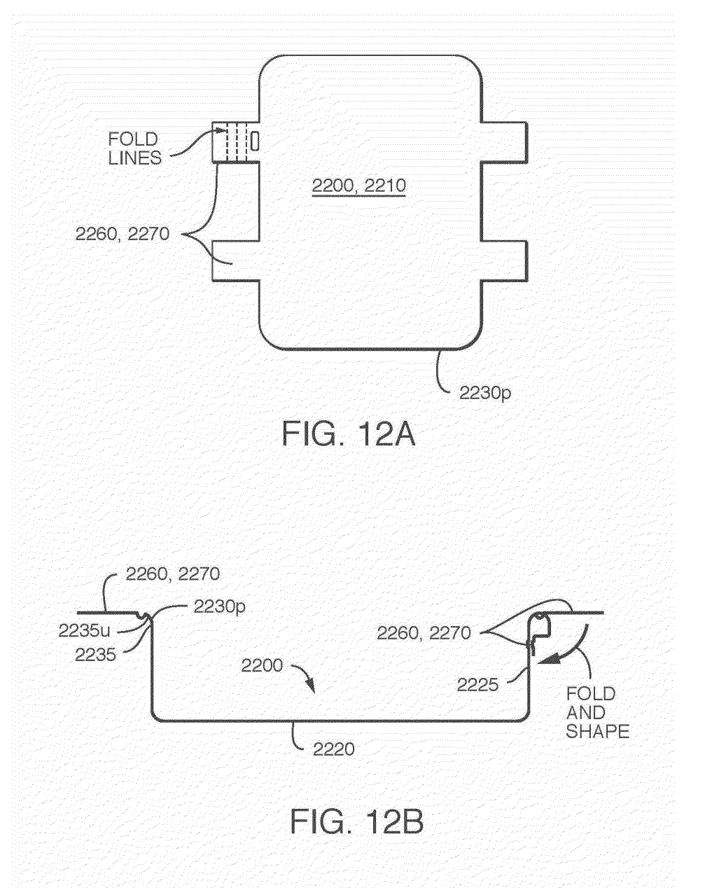

Referring still to FIG. 10, and additionally to FIGS. 11A, 11B and 12, illustrative embodiments of a handle unit 2140 configured for engagement with a paint receptacle 2200 in the form of a paint tray 2110 are shown and described. In each version, the paint tray 2210 includes a contoured closed bottom wall 2220 and four side walls 2225 joined to, and extending upwardly from, the bottom wall toward and open receptacle top end 2230 defined by a top-end periphery 2230p. The top end periphery 2230p includes an outwardly extending receptacle lip 2235 with a lip underside 2235u. Although the tray 2210 could include multiple, separate receptacle lips 2235, each tray 2210 in the embodiments illustrated includes a single receptacle lip 2235 that is coextensive with the entire periphery of the receptacle 2200 (tray 2210).

While the overall inventive concept is equally applicable to tray-type paint receptacles 2200 of different shapes such as, for example, paint totes with square peripheries, each tray 2210 of the illustrative examples depicted in FIGS. 10-12 has a substantially rectangular periphery wherein two of the parallel side walls 2225 extend longitudinally along a tray axis A_{T} and are joined by the two mutually parallel shorter side walls 2225. In the example of FIG. 10, the handle unit 2140 is, like the handle units 2110, a single piece of rod or wire contoured to define first and second prongs 2150a and 2150b depending from a hand-grip portion 2160 through, respectively, first and second connector portions 2155a and 2155b. With each of the prongs 2150a and 2150b selectively engaged with a lip underside 2235u, the handle-grip portion 2160 is situated above the paint receptacle 2200 and, as viewed downwardly from above (not shown), centered between the two longer parallel walls 2225 such that the handle-grip portion 2160 extends in parallel with the tray axis A_{T}. Because there will be a general balance in paint load on either side the tray axis A_{T} regardless the amount of paint contained therein, orienting the handle-grip portion 2160 in parallel with the tray axis A_{T} provides better balance of the tray 2210 as opposed, for example, the embodiment of FIGS. 8 and 9 in which the handle-grip 1905 extends perpendicularly to the tray axis A_{T}.

Shown in FIGS. 11A and 11B is another embodiment of a paint receptacle and handle assembly. The reference numbers used to refer to various elements are the same as those used relative to the tray embodiment of FIG. 10 where there is sufficient correspondence between elements. FIG. 11A is a perspective view showing a combination paint receptacle 2200 (tray 2210) and handle unit 2140 before the handle unit 2140 has been engaged with the paint tray 2210, and with arrows indicating how the prongs 2150a and 2150b are introduced under the lip underside 2235u. A difference between the version of FIGS. 11A and 11B, and that of FIG. 10, is that in the former, the connector portions 2155a and 2155b are pivotably coupled to the handle-grip portion 2160. In this way, the prongs 2150a and 2150b can be swung inwardly or outwardly—as indicated by the double-headed arcuate arrow—in order to engage the lip underside(s) 2235u of receptacles 2200 of various widths.

As best seen in the side view of FIG. 11B, in order to maintain engagement between the prongs 2150a and 2150b and the lip underside 2235u, the paint receptacle 2200 is provided with prong retainers 2260. The prong retainers 2260 depicted are configured as retaining tabs 2270 integrally formed or otherwise depending from the top-end periphery 2230p. Each tab 2270 at least partially envelops a lengthwise portion of one of the first and second prongs 2150a and 2150b in order to prevent the receptacle 2200 from unintentionally dislodging from the handle unit 2140. The nature of the retaining tabs 2270 might differ among tray types. For example, where the paint tray 2210 is constructed of a relatively rigid, self-supporting material such as stamped metal sheets, the retaining tabs 2270 might only partially envelop the prongs 2150a and 2150b, and may even be configured to provide a “spring force” against them such that the prongs 2150a and 2150b are “snapped into place.”

However, use of handle units 2140 such as those shown, by way of non-limiting example, in FIGS. 10-11B with paint receptacles 2200, and more particularly, paint trays 2210, constructed of “lighter,” less rigid materials (e.g., thermal-formed and/or stamped polymeric-material sheets) is envisioned and, therefore, indicates retaining tabs 2270 that fully envelop the prongs 2150a and 2150b so that the filled tray 2210 does not collapse when filled with paint. By way of example, shown in FIGS. 12A and 12B are two schematic views—a top view in the upper portion and a side view in the lower portion—of a paint tray 2210 formed from a sheet of material. Referring to the top view, integrally formed with, and depending from, the top-end periphery 2230p is a set of four retaining tabs 2270 before they have been “wrapped” or contoured. Shown on the right side of the lower view is a tab 2270 at different stages in a folding process. In various versions, the tab 2270 is folded so that a portion thereof is in contact with the side wall 2225 from which it depends in order to define a closed loop or sleeve configured to completely envelop a lengthwise portion of a prong 2150a or 2150b. In various versions, the portion of the tab 2270 in contact with the side wall 2225 is secured to the side wall 2225 through glue or other adhesive, heat fusion and/or welding, by way of non-limiting example. In alternative versions, the final folding and securing stage is performed as part of manufacturing or is left to an end consumer. In the latter case, the tab 2270 might include a removable backing (not shown) which, when removed, exposes an adhesive (not shown).

The foregoing is considered to be illustrative of the principles of the invention. Furthermore, since modifications and changes to various aspects and implementations will occur to those skilled in the art without departing from the scope and spirit of the invention, it is to be understood that the foregoing does not limit the invention as expressed in the appended claims to the exact constructions, implementations and versions shown and described.

What is claimed is:

1. A universal paint applicator configured for use in combination with a roller cover including a cylindrical roller-cover core with an inside surface and an outside surface carrying an absorbent material for alternatively absorbing and depositing paint on a surface, the applicator comprising:
a handle assembly that extends longitudinally along a handle axis;
first and second pivot arm assemblies carried by, and extending forwardly of, the handle assembly such that the pivot arms are disposed symmetrically about the handle axis, each pivot arm assembly including a pivot arm having a proximate end by which it depends from the handle assembly for rotation about a pivot arm axis and a distal end opposite the proximate end and disposed forwardly of the handle assembly;
a bi-directional pivot arm actuator carried by the handle and cooperatively linked to each pivot arm assembly such that movement of the actuator in a first direction causes the pivot arms to rotate toward one another and movement of the actuator in a second direction, opposite the first direction, causes the pivot arm assemblies to rotate away from one another; and
a hub assembly pivotably coupled to the distal end of each of the first and second pivot arms for angular movement about a hub-pivot axis, each hub assembly including a hub axle and a hub mounted for rotation on the hub axle about a hub-rotation axis defined by the hub axle, each hub including an outer surface configured to frictionally engage the inside surface of the roller-cover core such that the hubs of the first and second pivot arms cooperate to retain the roller cover between the pivot arms; wherein
the hub-rotation axes, hub-pivot axes and pivot arm axes are movable into disparate mutual orientations such that, when the pivot arms are spread to various degrees, the hub-rotation axes can be aligned to define a common roller-cover rotation axis so that the roller cover cooperatively retained by the hubs can be of any length between a predetermined minimum length and a pre-determined maximum length.

2. The paint applicator of claim 1 wherein
(i) each pivot arm assembly further includes at the proximate end of each pivot arm a pivot arm gear having pivot-gear teeth; and
(ii) the pivot arm actuator comprises a worm-drive shaft carrying a worm gear with teeth that intermesh with the pivot-gear teeth of each pivot arm such that rotation of the worm-drive shaft in a first direction causes the pivot arms to rotate about their pivot arm axes inwardly toward one another and rotation of the worm-drive shaft in a second direction opposite the first direction causes the pivot arms to mutually spread in an outwardly direction thereby facilitating, respectively, engagement and disengagement of the outer surfaces of the hubs with the inside surface of the roller-cover core.

3. The paint applicator of claim 1 wherein
(i) each of the first and second pivot arm assemblies further includes at the proximate end of its respective pivot arm a pivot arm gear having pivot-gear teeth; and
(ii) the pivot-gear teeth of the first pivot arm assembly are directly intermeshed with the pivot-gear teeth of the second pivot arm assembly such that the rotation of one of the pivot arms in one of an inwardly and outwardly direction causes the rotation of the other pivot arm in, respectively, an inwardly and outwardly direction with respect to the handle axis, each pivot arm thereby serving as the bi-directional pivot arm actuator for the other pivot arm.

4. A combination paint receptacle and handle assembly for lifting the receptacle comprising:
a paint receptacle configured for temporarily containing liquid paint to be applied to a surface, the receptacle including a closed bottom wall and at least one side wall joined to, and extending upwardly from, the bottom wall toward an open receptacle top end defined by a top-end periphery, the periphery including at least one outwardly extending receptacle lip having a lip underside; and
a handle unit including a hand-grip portion and first and second prongs depending from the hand-grip portion, the prongs being mutually spaced apart and configured such that each of the prongs can selectively engage at least one lip underside such that a user can lift the paint receptacle by the hand-grip portion.

5. The receptacle and handle assembly of claim 4 wherein the paint receptacle is one of (i) a rigid, self-supporting paint tray and (ii) a paint tray liner.

6. The receptacle and handle assembly of claim 5 wherein, in addition to at least one lip, the receptacle further includes at least two retaining tabs, each tab extending outwardly from the periphery and being configured to at least partially envelop a lengthwise portion of each of the first and second prongs of the handle unit in order to prevent the receptacle from unintentionally dislodging from the handle unit.

7. The receptacle and handle assembly of claim 6 wherein the tabs are integrally formed with the periphery and the receptacle is made by at least one of stamping and thermal forming a sheet of material.

8. The receptacle and handle assembly of claim 7 wherein the sheet of material is one of metal and a polymeric material.

9. The receptacle and handle assembly of claim 4 wherein the at least one receptacle lip is a single receptacle lip co-extensive with the entire periphery of the receptacle.

10. The receptacle and handle assembly of claim 9 wherein the top-end periphery is circular in configuration.
